(19) United States
(12) Patent Application Publication
(10) Pub. No.: US 2007/0239082 A1
(43) Pub. Date: Oct. 11, 2007

(54) Shock Wave Treatment Device

(75) Inventors: Reiner Schultheiss, Illighausen (CH); Johannes Knauss, Konstanz (DE); Erwin Ignaz Simnacher, Reichenau (DE)

Correspondence Address: DAVID L. KING, SR., 5131 N.E. COUNTY ROAD 340, HIGH SPRINGS, FL, 32643, US

(73) Assignee: GENERAL PATENT, LLC, Marietta, GA (US)

(21) Appl. No.: 11/559,516

(22) Filed: Nov. 14, 2006

Related U.S. Application Data
(60) Provisional application No. 60/763,018, filed on Jan. 27, 2006.

(51) Int. Cl. A61H 1/00; A61H 1/02

(52) U.S. Cl. 601/4; 601/2

(57) ABSTRACT

The system for treating an internal organ has a generator source for producing a shock wave connected to a handheld or small shock wave applicator device 2, wherein the external housing 16 of the device 2 is hermetically sealed in a non-electrically conductive insulating skin membrane 5 being of a polymer material, preferably a silicone rubber or polyurethane rubber. Preferably the entire device 2 including the connectors 32, 33 and at least a 20 cm portion of attached cable 1 is sealed using a dip coating process or alternatively can use an insert molding process wherein the device 2 is placed in a mold 400 and the skin membrane 5 is injection molded around the entire housing 16 and the cable 1 has an outer skin 5 that abuttingly seals at a connection 32, 33 to the housing 16. The device 2 may further include an internal vacuum conduit connected to a vacuum system to detect leakages and in use may be used with a sterile sleeve cover with a similar vacuum system for leakage detection.

### RELATED APPLICATIONS

This application is a continuation in part and claims priority to U.S. Provisional Application No. 60/763,018 filed on Jan. 27, 2006 entitled “Shock Wave Treatment and Method of Use” and also claims priority to U.S. Ser. No. 11/422,388 filed on Jun. 6, 2006 entitled “Shock Wave Treatment Device and Method of Use”.

### FIELD OF THE INVENTION

The present invention relates to a method and a device for generating shock waves generally, more specifically to an improved method and device for treating internal organs or tissue.

### BACKGROUND OF THE INVENTION

The use of shock waves to treat various conditions affecting the bone or soft tissues of a mammal, usually a human is known.

Shock waves produce a high energy pulse that when focused can pulverize hard calcium deposits such as kidney stones. This technology is commonly and very successfully employed in lithotripsy.

More recently, the use of shock waves has been employed in the art of healing non union bone fractures and in treating soft tissues and organs extracorporeally in a non-invasive manner.

The pressure pulse or wave form when applied was thought to require a high energy to achieve a deep penetration to an affected organ, as a result focused beams were transmitted that had a focal point or region set at a distance deep enough to penetrate the underlying organ or tissue. It was believed that the skeletal system of hard bone mass greatly dampened the wave pattern making it difficult to treat such organs as the heart.

In U.S. Pat. No. 6,755,821 B1 entitled “A System and Method for Stimulation and/or Enhancement of Myocardial Angiogenesis” a proposed solution to treating the heart using shock waves was proposed. Shock-waves were applied using a combination lithotripsy probe/balloon system, comprising a needle and cannular balloon which can be inserted through the skin at a point between the ribs into the cavity beneath the chest wall and overlying the heart. Alternatively, the shock-wave can be administered extracorporeally or via a catheter. A fluid injector was connected to the balloon, allowing it to be inflated with saline or other appropriate fluid to fill the space (for transmission of shock waves and/or to displace tissue—such as lung) and contact the surface of the heart. A shock-wave (acoustic) generator was used to generate shock-waves through the lithotripsy probe, through the fluid and into the myocardial tissue. The fluid provides a uniform medium for transmission of the acoustic energy, allowing precise focus and direction of the shock-wave to induce repeatable cavitation events, producing small fissures which are created by the cavitation bubbles. In this case, channels would not be ‘drilled’ into the heart muscle, minimizing trauma to the tissue while still creating conditions that will stimulate increased expression of angiogenic growth factors.

The concept in U.S. Pat. No. 6,755,821 provides an alternative to procedures in place today that rely on lasers. As stated in the above referenced patent.

“Transmyocardial revascularization (TMR) using a laser (sometimes referred to as TMLR, LTMR, PMR, PTMR, or DMR) has been developed over the past decade, initially by a company called PLC Systems, Inc., of Franklin, Mass. PLC's system utilizes a high power (800-1000 W) carbon dioxide (CO.sub.2) laser which drills small channels in the outside (epicardial) surface of the myocardium in a surgical procedure. The holes communicate with the left ventricle, which delivers blood directly to the heart muscle, mimicking the reptilian heart. Many other companies are developing laser TMR systems, most introducing the laser light via optical fibers through a flexible catheter, making the procedure less-invasive. These companies include Eclipse Surgical Technologies, Inc., of Sunnyvale, Calif., and Helionetics, Inc., of Van Nuys, Calif. The Eclipse TMR system uses a Ho:YAG laser with a catheter-delivered fiber optic probe for contact delivery to the myocardium. The Helionetics system is based on an excimer laser. In addition to the holmium:YAG and excimer lasers, and other types of lasers have been proposed for TMR.

### While the channels created during TMR are known to close within 2-4 weeks, most patients tend to improve clinically over a period of 2-6 months.

Such clinical improvement may be demonstrated by reduction in chest pain (“angina”), and a dramatic increase in exercise tolerance (“ETT”, or treadmill test). The mechanism of laser TMR is not fully understood, but it is postulated that the laser causes near-term relief of angina through denervation or patent channels, with subsequent long-term clinical improvement due to angiogenesis, i.e., growth of new blood vessels, mainly capillaries, which perfuse the heart muscle. These new “collateral” vessels enable blood to reach downstream (“distal”) ischemic tissues, despite blockages in the coronary arteries. Some of the possible mechanisms by which the laser induces angiogenesis could include activation of growth factors by light, thermal, mechanical, cavitational or shockwave means. In fact, all lasers which have been successfully used for TMR are pulsed systems, and are known to create shock waves in tissue, and resulting cavitation effects.”

The problem of delivery of a shock wave to an internal organ is more complex than simply avoiding bone tissue. In the case of treating the heart special care must be taken to avoid damaging the thin membrane of the nearby lung. Shock waves inadvertently transmitted to this area can cause bleeding and other damage.

Another problem for the use of shock waves is internal organs are three dimensional masses that in the case of the heart need the waves to be directed from two sides front and back, more preferably from at least three directions.

Accordingly the devices such as the laser or the shock wave system of U.S. Pat. No. 6,755,821 are limited to one surface of the heart or would require multiple points of entry.

Another problem associated with such devices is the need to maintain a sterile surgical site in an area surrounded by body fluids and to also avoid electrical shorts and extraneous electrical current flows from the spark generating shock wave applicator device.

The team of inventors of the present invention has developed both a device and a methodology for treating an internal organ which addresses these limitations and provides a multiple direction system for delivering shock waves.

### SUMMARY OF THE INVENTION

The system for treating an internal organ has a generator source for producing a shock wave connected to a handheld or otherwise small shock wave applicator device, wherein the external housing of the device is hermetically sealed in a non-electrically conductive insulating skin membrane. The membrane being of a polymer material, preferably a silicone rubber or polyurethane rubber. The device has a reflector cover or lens of a flexible silicone membrane, alternatively the reflector cover or lens covering can be a hard plastic or elastomeric material that freely passes acoustic waves with minimal or no dampening effects insuring an acoustic wave pattern or form occurs with minimal transmission losses. Preferably the entire device including the reflector cover or lens covering and the cable connections and at least a portion of the length of the cabling is sealed using a dip coating process or alternatively can use an insert molding process wherein the device is placed in a mold and the skin membrane is injection molded around the entire housing and the cabling has a coating that abuttingly seals against the skin membrane on the housing or coated connectors. Alternatively a sealed outer skin can be formed using a vacuum molding or packaging by pulling a vacuum over the device over which a plastic cover encapsulates the device and which is sealed after the vacuum has been applied to achieve a form fitting outer skin. In a preferred embodiment the shock wave applicator device has a side-firing shock wave head having a variable angle adjustment. The inclination of the shock wave head can be set an inclination to reach the organ at various locations or surfaces or can be inclined continuous to vary the treatment surface area.

The pulse or wave propagation being emitted from the head on a sideways direction relative to the device enables the surgeon to rotate the head about a longitudinal axis of the device or tilt the head relative to the length of the device providing an infinite number of angular choices for emitting the wave pattern. The device may employ acoustic shock waves from electromagnetic or piezo electric, ballistic or electro hydraulic sources or generators.

In a preferred embodiment the applicator device is intended for a single surgical procedure and after being used should be discarded. The entire device is accordingly relatively low cost in its manufacture and has a basic but very effective design. The head portion or end includes two electrodes or two tips in one assembly of an electrode to create a shock wave generating spark, and the head portion further includes a reflector for redirecting and shaping the wave pattern. The head is preferably round or oval of a small geometric size sufficient to be positioned under or around the soft tissue of an organ to permit access around the periphery of the organ being treated. Alternatively the reflector and head of the applicator can be an oval of more ellipsoidal shape with the major axis lying along the longitudinal axis of the device. In such a case the minor diameter transverse to the longitudinal axis can be made as small as 4 or 3 cm or preferably 2 cm or less. The device being sealed in a skin membrane has an integral shielding means which would insure the only emitted shockwave energy was directed outward from the reflector cover and the covering through skin membrane overlying these components of the shock wave head. The skin membrane preferably would be a resilient cushion covering thick enough along at least the back and preferably the sides of the applicator head to dissipate any transmitted acoustic energy. In these regions the outer skin preferably is a second material having an outer skin with an inner foam or porosity of entrapped air underlying the skin as is common in some foam filled urethane materials. This is particularly useful to prevent damage to the thin lung membrane during an open heart procedure. Additional shielding means can be made a part of a separate sterile sleeve or even a separate sterile layer positioned between the treated heart and the underlying lung.

The applicator device may be used by placing it inside a disposable sterile sleeve or cover. In such a case the applicator can be simply cleaned with a disinfecting agent prior to use as it is not directly exposed to the tissue which is greatly improved because the skin membrane is relatively smooth with no crevices. Alternatively the applicator without a separate sleeve or cover can be used wherein the applicator is sterilized prior to use. Preferably each disposable applicator is sealed in a sterile package and gas or radiation sterilized, or steam prior to being used. Ethlyene Oxide gas or any other suitable gas or gamma radiation being typical sterilization sources. In either use the device with the sleeve or cover or the applicator without a cover should be coupled acoustically to the treated tissue or organ by a sterile coupling fluid or viscous gel like ultrasound gels or even NaCl solution to avoid transmission loss.

The method of employing the shock wave applicator device comprises the steps of providing an at least partially exposed or direct access portal to an organ, activating an acoustic shock wave generator or source to emit acoustic shock waves from a shock wave applicator head of a shock wave applicator; and subjecting the organ to the acoustic shock waves stimulating said organ wherein the organ is positioned within an unobstructed path of the emitted shock waves, positioning the shock wave head adjacent to and on an inclination relative to the organ, firing the electrodes and emitting a shock wave pattern in a generally transverse direction relative to the applicator. The method further comprises repositioning the shock wave head at a second position or inclination and firing the electrode. The step of positioning the applicator may further include holding the device at an angle between 0° and about 360° more typically between 0° and 180° relative to the organ prior the firing the electrodes. The emitted shock waves can be focused convergent waves, divergent or near planar waves. Alternatively the emitted shock waves can be convergent having a geometric focal volume or focal point spaced at a distance of at least a few mm from the focal point. The organ is a tissue having cells. The tissue can be an organ of a mammal. The mammal may be a human or an animal. The organ may be a heart, a brain, a liver or a kidney or any other organ with associated other types of tissue. The tissue may be a part of the vascular system, a part of the nervous system, a part of the urinary or reproductive system.

The method of stimulating an organ can further include a result wherein the step of subjecting the organ to acoustic shock waves stimulates at least some of said cells within said organ to release or produce one or more of nitric oxygen (NO), vessel endothelial growth factor (VEGF), bone morphogenetic protein (BMP) or other growth factors.

The organ can be a tissue having a pathological condition, a tissue having been subjected to a prior trauma, a tissue having been subjected to an operative procedure, or a tissue in a degenerative condition. The organ is at least partially surgically exposed if not removed from the patient during the exposure to an unobstructed shock wave treatment.

The method may further include the steps of activating the applicator device to transmit the shock wave pulses in response to a repetitive body or organ function. In particular the method may include triggering the shock wave pulse during the R phase of the QRS and T curve, alternatively the use of the critical T phase could be used although this is not preferred, or the contraction of a heart wherein the R phase is that portion of the heartbeat depicted by and including the peak amplitude on an ECG monitored display. This controlled pulse triggering avoids irregular heartbeat patterns from being stimulated by the transmission of the shockwave pulses.

### Definitions

“cirrhosis” liver disease characterized pathologically by loss of the normal microscopic lobular architecture, with fibrosis and nodular regeneration. The term is sometimes used to refer to chronic interstitial inflammation of any organ.

A “curved emitter” is an emitter having a curved reflecting (or focusing) or emitting surface and includes, but is not limited to, emitters having ellipsoidal, parabolic, quasi parabolic (general paraboloid) or spherical reflector/reflecting or emitting elements. Curved emitters having a curved reflecting or focusing element generally produce waves having focused wave fronts, while curved emitters having curved emitting surfaces generally produce a variety of wave fronts including focused, unfocused parallel and also divergent wave fronts.

“Divergent waves” in the context of the present invention are all waves which are not focused and are not plane or nearly plane. Divergent waves also include waves which only seem to have a focus or source from which the waves are transmitted. The wave fronts of divergent waves have divergent characteristics. Divergent waves can be created in many different ways, for example: A focused wave will become divergent once it has passed through the focal point. Spherical waves are also included in this definition of divergent waves and have wave fronts with divergent characteristics.

“extracorporeal” occurring or generated outside the living body.

A “generalized paraboloid” according to the present invention is also a three-dimensional bowl. In two dimensions (in Cartesian coordinates, x and y) the formula yⁿ=2px [with n being≠2, but being greater than about 1.2 and smaller than 2, or greater than 2 but smaller than about 2.8]. In a generalized paraboloid, the characteristics of the wave fronts created by electrodes located within the generalized paraboloid may be corrected by the selection of (p(−z,+z)), with z being a measure for the burn down of an electrode, and n, so that phenomena including, but not limited to, burn down of the tip of an electrode (−z,+z) and/or disturbances caused by diffraction at the aperture of the paraboloid are compensated for.

“myocardial infarction” infarction of the myocardium that results typically from coronary occlusion, that may be marked by sudden chest pain, shortness of breath, nausea and loss of consciousness, and that sometimes results in death.

“open heart” of, relating to, or performed on a heart which could be temporarily relieved of circulatory function and surgically opened for inspection and treatment.

A “paraboloid” according to the present invention is a three-dimensional reflecting bowl. In two dimensions (in Cartesian coordinates, x and y) the formula y²=2px, wherein p/2 is the distance of the focal point of the paraboloid from its apex, defines the paraboloid. Rotation of the two-dimensional figure defined by this formula around its longitudinal axis generates a de facto paraboloid.

“Plane waves” are sometimes also called flat or even waves. Their wave fronts have plane characteristics (also called even or parallel characteristics). The amplitude in a wave front is constant and the “curvature” is flat (that is why these waves are sometimes called flat waves). Plane waves do not have a focus to which their fronts move (focused) or from which the fronts are emitted (divergent). “Nearly plane waves” also do not have a focus to which their fronts move (focused) or from which the fronts are emitted (divergent). The amplitude of their wave fronts (having “nearly plane” characteristics) is approximating the constancy of plain waves. “Nearly plane” waves can be emitted by generators having pressure pulse/shock wave generating elements with flat emitters or curved emitters. Curved emitters may comprise a generalized paraboloid that allows waves having nearly plane characteristics to be emitted.

A “pressure pulse” according to the present invention is an acoustic pulse which includes several cycles of positive and negative pressure. The amplitude of the positive part of such a cycle should be above about 0.1 MPa and its time duration is from below a microsecond to about a second. Rise times of the positive part of the first pressure cycle may be in the range of nano-seconds (ns) up to some milli-seconds (ms). Very fast pressure pulses are called shock waves. Shock waves used in medical applications do have amplitudes above 0.1 MPa and rise times of the amplitude are below 100 ns. The duration of a shock wave is typically below 1-3 micro-seconds (μs) for the positive part of a cycle and typically above some micro-seconds for the negative part of a cycle.

Waves/wave fronts described as being “focused” or “having focusing characteristics” means in the context of the present invention that the respective waves or wave fronts are traveling and increase their amplitude in direction of the focal point. Per definition the energy of the wave will be at a maximum in the focal point or, if there is a focal shift in this point, the energy is at a maximum near the geometrical focal point. Both the maximum energy and the maximal pressure amplitude may be used to define the focal point.

### BRIEF DESCRIPTION OF THE DRAWINGS

The invention will be described by way of example and with reference to the accompanying drawings in which:

FIG. 1 is a perspective view of the shock wave applicator according to the present invention.

FIG. 2 is a second perspective view showing the device with a second lens cover prior to being dipped.

FIG. 2A is the device being dipped.

FIG. 2B is a third perspective view of the device being shown after dipping.

FIG. 3 is a view of the device being insert molded to form a skin.

FIG. 4 is a perspective view showing the housing partially cut away to expose the internal components of the device.

FIG. 5 is a plan view of the shock wave applicator internal components with the external housing and handle removed.

FIG. 6 is a perspective view of a sterile prophylactic sleeve for use with the applicator.

FIG. 7 is a perspective view of a frontal region of a heart being shock wave treated by a shock wave head according to the method of the present invention.

FIG. 8 is a perspective view of the posterior region of a heart being shock wave treated according to the present inventive method.

FIG. 9 is a perspective view of a brain being shock wave treated according to the method of the present invention.

FIG. 10 is a perspective view of a liver being shock wave treated according to the method of the present invention.

FIG. 11 is a perspective view of a pair of kidneys, one of said kidneys being shown treated by shock wave from shock wave head according to the method of the present invention.

FIG. 12 is a schematic view of a shock wave system according to the present invention.

FIGS. 13-17 are illustrations of various shock wave patterns.

FIG. 18 is a separate shielding means for use with the device of FIG. 1.

FIG. 19 is an alternative embodiment employing an ellipsoidal applicator head.

FIG. 20 is a view of a sterile applicator sleeve or cover with an integral shielding means.

FIG. 21 is a perspective view showing an alternative embodiment with the housing partially cut away to expose the internal components of the device; the device having an internal vacuum system.

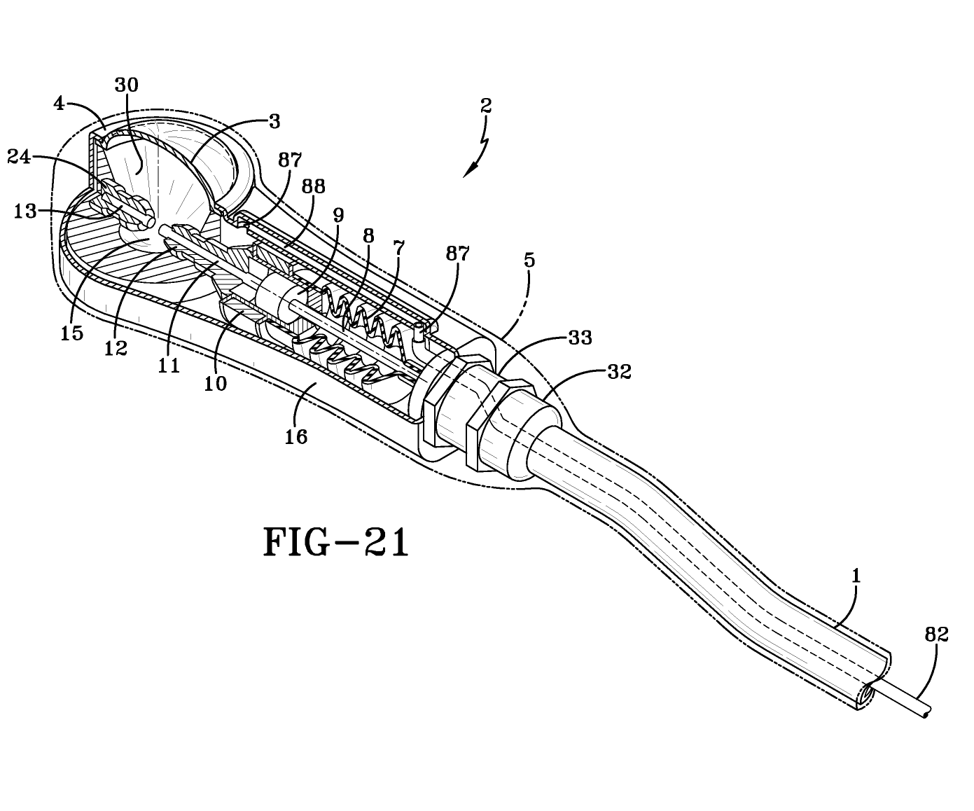

FIG. 22 is a perspective view of an alternative sterile prophylactic sleeve with a vacuum system for use with the applicator.

FIG. 23 is a perspective view of an alternative embodiment applicator with an internal vacuum system.

### DETAILED DESCRIPTION OF THE INVENTION

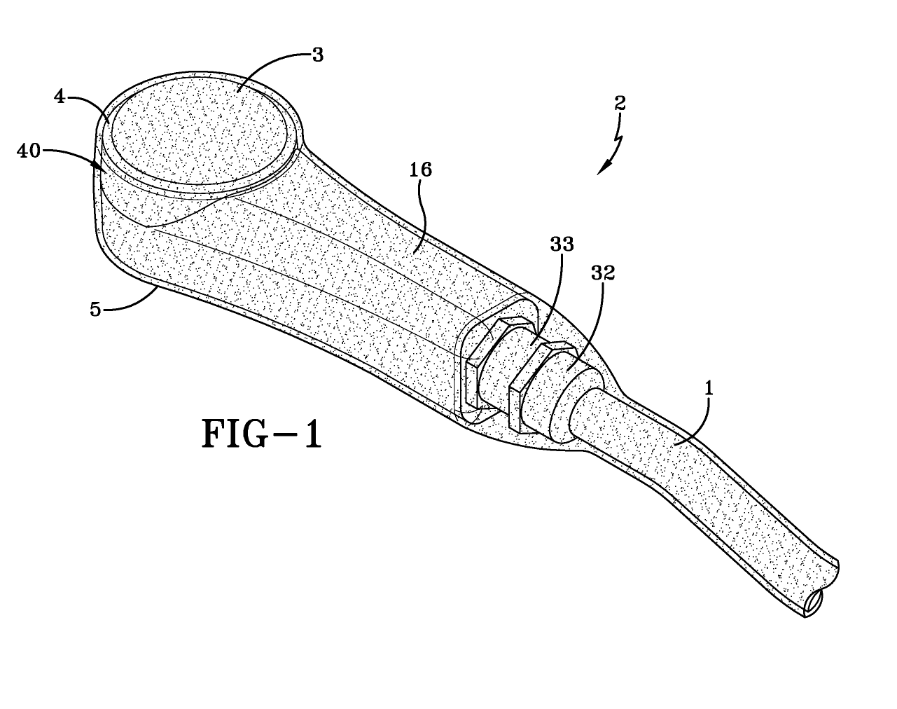

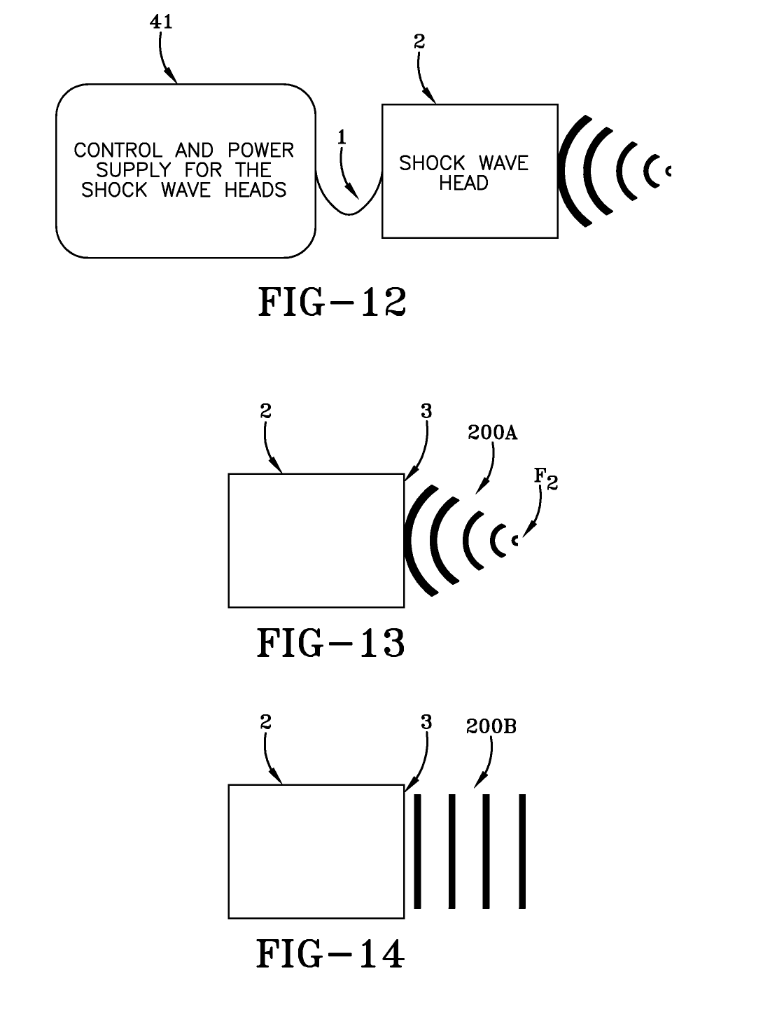

With reference to FIG. 1 a small portable hand-held shock wave applicator device 2 is illustrated. The shock wave applicator 2 has a cable 1 extending from an end of an applicator housing 16. The cable 1 is connected to a shock wave generator (schematically illustrated in FIG. 12) and as illustrated in FIG. 1 fastened to the applicator housing 16 via a pair of threaded connectors 32, 33.

At the opposite end of the applicator 2 is an applicator head portion 40 as shown the applicator head portion 40 has a rounded contour with a diameter of approximately 5 cm, preferably smaller which enables the device to be easily positioned around or under the organ to be treated. It is in this portion 40 that the shock wave patterns are produced, reflected and emitted to the organ or tissue 100 being treated. The head portion 40 includes a reflector cover 3 which is sealed and retained by the annular fixation ring 4 which secures and holds the reflector cover 3. The reflector cover 3 is made of a flexible silicone membrane or alternatively or a hard plastic shell of polyethylene, polypropylene, polyurethane or similar material to provide additional protection from cracks. The entire device is then hermetically sealed in an outer skin membrane 5 of silicone or other energy absorbing and insulating material having a thickness of 0.2 mm or greater. Preferably the coating extends beyond the cable connectors 32, 33 and along a length of at least 20 cm or more of the cable 1.

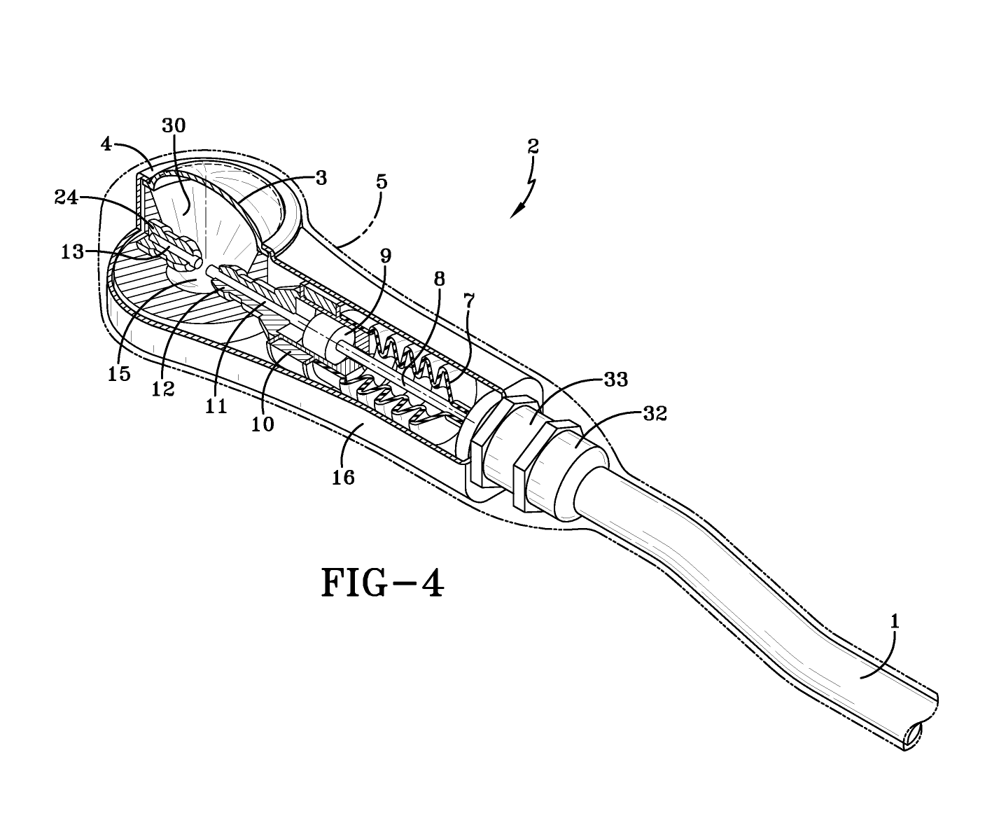

With reference to FIG. 4 a cross sectional view of the shock wave applicator device 2 is shown exposing the internal components. Passing through the cable 1 is a high voltage cable or rod 8 surrounded by an elastomeric insulation bellows 7. At an end of the coil 10 is an insulator inner probe housing 12 for centering and holding an inner probe tip or electrode 11. At an opposite side of the applicator head portion 40 is an outer tip or electrode 13 embedded in an outer insulator housing 24. As shown in FIG. 4 the tips 11, 13 are aligned and gapped at a distance S to facilitate a spark gap which creates the shock wave when energized. Partially surrounding the tips 11, 13 is a metal reflector 15. The reflector 15 opens to the reflector cover 3 and the internal surface provides the shape of the emitted wave patterns as a function of its geometric shape. The reflector 15 can be made of a numerous variety of shapes to achieve a desired wave pattern as will be discussed later in detail. In a preferred low cost embodiment the electrode tips 11, 13 are permanently fixed and after a series of activations the tips will erode changing the spark gap which means the device can only be used for a single procedure. After use the device must be discarded or alternatively torn apart by cutting the skin membrane 5 and disassembling the device to replace the burnt electrodes and repair the other components as necessary. It is therefore possible to completely refurbish the device if so desired and a new skin membrane 5 applied. However, it is recommended the low cost device should be simply discarded and not reused.

An alternative to the fixed electrode tips 11, 13 is to provide an upgraded device with an adjustable tip wherein the spark gap can be maintained during use, this upgrade device shown in FIG. 4 employs a magnet 9 and a coil 10 for moving the magnet as the coil 10 produces a magnetic field the magnet is moved and therefore the electrode tip moves correspondingly maintaining the spark gap at the desired predetermined setting. Other methods of moving the inner tip include using motor and gear box, hydraulic, pneumatic or other means to control movement of the electrode tip to keep the spark gap optimally distanced. It is believed even this upgraded automatic adjustment device can be produced such that the entire device can be produced for a single use, however, the ability to cut the skin membrane 5 and peel it from the housing provides a simple way to refurbish the device and replace the skin membrane 5 to permit reuse.

A cavity 30 is formed between the reflector cover 3 and the reflector 15 which is filled with a fluid medium preferably filled with water. The water helps create a cavitation bubble when the spark is generated from which a shock wave 200 is propagated outward to the tissue or organ 100 to be treated.

It is possible to reduce the size of the applicator head 40 from about 5 cm maximum to much smaller almost half that size by reducing the volume in the cavity 30 and the size of the reflector 15. This can be accomplished by applying over pressure to the volume around the tips 11, 13 of the electrode to control the size of the emitted shock wave bubble. The size of the bubble will increase with the energy and this over pressure put on the tips 11, 13 of the electrode enables the wave propagation to be effectively the same as in the larger sized reflector head.

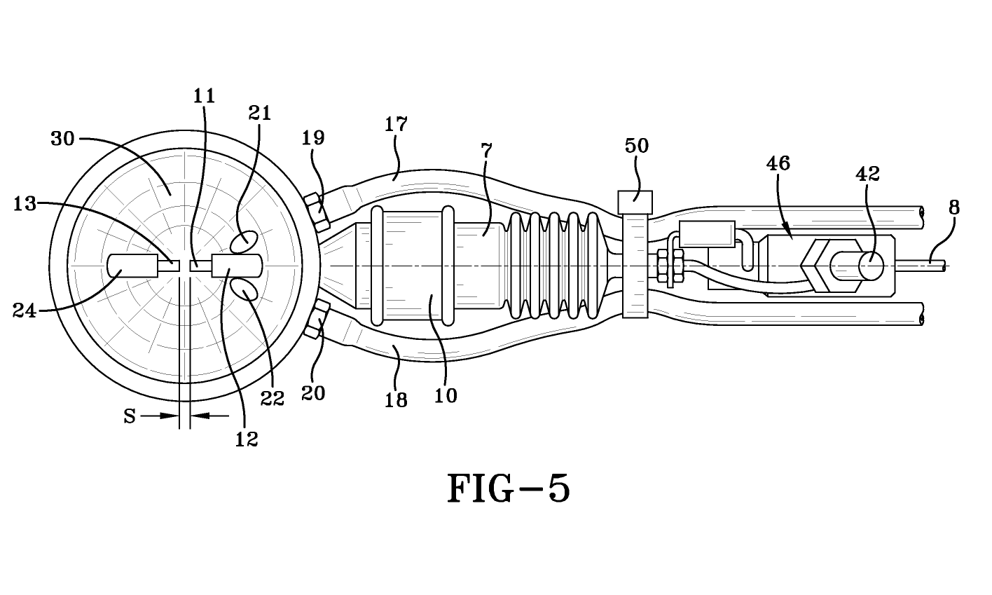

With reference to FIG. 5 the shock wave applicator 2 is shown with the housing 16 removed. As shown there are two water hoses illustrated, one water hose 17 is an inlet or supply hose 17 which is attached to the reflector 15 of the applicator head by a connector 19. Water from the inlet hose 17 can be pumped into the reflector cavity 30 through inlet holes or passageways 21. Water from the reflector cavity 30 can be removed via outlet holes or passageways 22 and sent back through the cable 1 by way of the outlet hose 18 which is connected to the reflector 15 by the connector 20. As shown the two hoses 17, 18 can be snugly secured on each side of the insulator bellows 7 by a strap 50.

As further shown the activation of the shock wave head 40 can be triggered by the surgeon by depressing the switch button 42 which closes the switch 46 allowing the high voltage current to pass along the cable or rod 8. Preferably this switch 46 including the switch button 42 is sealed within the housing 16 and the housing 16 can be squeezed to depress the switch button 42. This minimizes the protruding portions on the device 2 which is important to avoid damaging vessels or nerves on insertion of the device 2 into the access portal provided by the surgical procedure. The switch 46 could also be replaced with a foot switch or a switch attached to the power and control unit 41.

As can easily be appreciated the use of high voltage electricity passing through the cable 1 along with input and output water lines 17, 18 creates a serious need for internal and external insulation of the device 2. The fact that the device further is coupled to a patient's exposed organ via a coupling gel means the electrical conductive path to the organ is both well grounded and provides virtually no resistance to electrical leakage. Such leakage could trigger a sudden stoppage of the heart or brain as stray electrical current passing through an exposed organ such as the brain or the heart could cause the organ to stop functioning and thus bring about sudden death. Accordingly to avoid such a risk the device is recommended for a one time use only after which it is discarded as the energy that the acoustic wave generates puts sizable loads on the components and as such repeated uses run a high risk of electric current or internal fluid leakage. Even with this precaution there is still a risk of leakage with a new device that can be virtually eliminated by the use of a device that is completely encapsulated in a hermetically sealed outer sheath covering or skin membrane 5. In practice it has been discovered that the entire shock wave applicator device 2 can be sealed in a silicone rubber or other insulating type elastomer such as polyurethane rubber such that the entire housing including the cable connectors 32, 33 and at least a portion length of the cable 1 is hermetically sealed, isolated and insulated from the patient. Not only does this reduce the risk of electrical leakage it also insures no internal fluid leakage from the device can leak into the surgical site which could lead to infection. Secondarily the device having such an insulating outer skin 5 provides an outer surface that is far less prone to injure the tissue or the organ being treated as the device is manipulated.

A secondary benefit of such a compliant skin like membrane 5 is the fact that external sterilization is sufficient to insure the device is safe for use. As a result a gas sterilization of the device will germicidally kill any surface bacteria on the insulating skin membrane 5 and therefore the device can be packaged in a sterile paper package or plastic package and be brought to the operating room for attachment to the generator control and power supply 41 without concerns of surface contamination if properly aseptically handled.

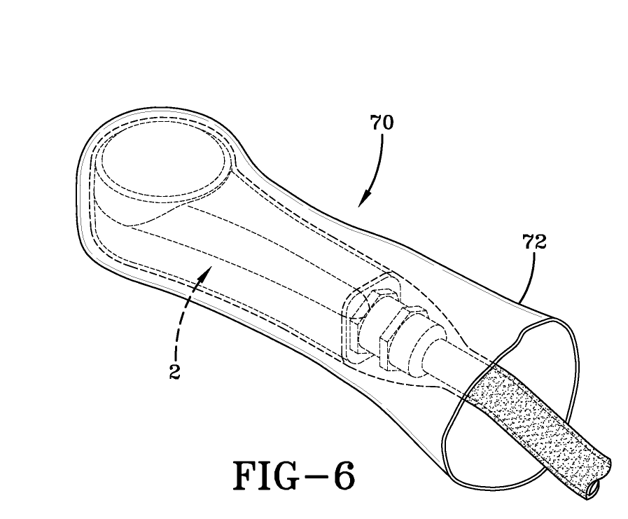

Alternatively other means of sterilization are possible such as gamma radiation, ultra violet and steam sterilization. As a secondary precaution the device can be aseptically wiped down with germicidal agents or ultrasonically cleaned and then placed in a sterile sleeve prior to use as shown in FIG. 6. In any event because the skin like membrane 5 seals and covers the entire outer surface of the device 2 it has no seams or crevices for trapping germs as is possible with other devices.

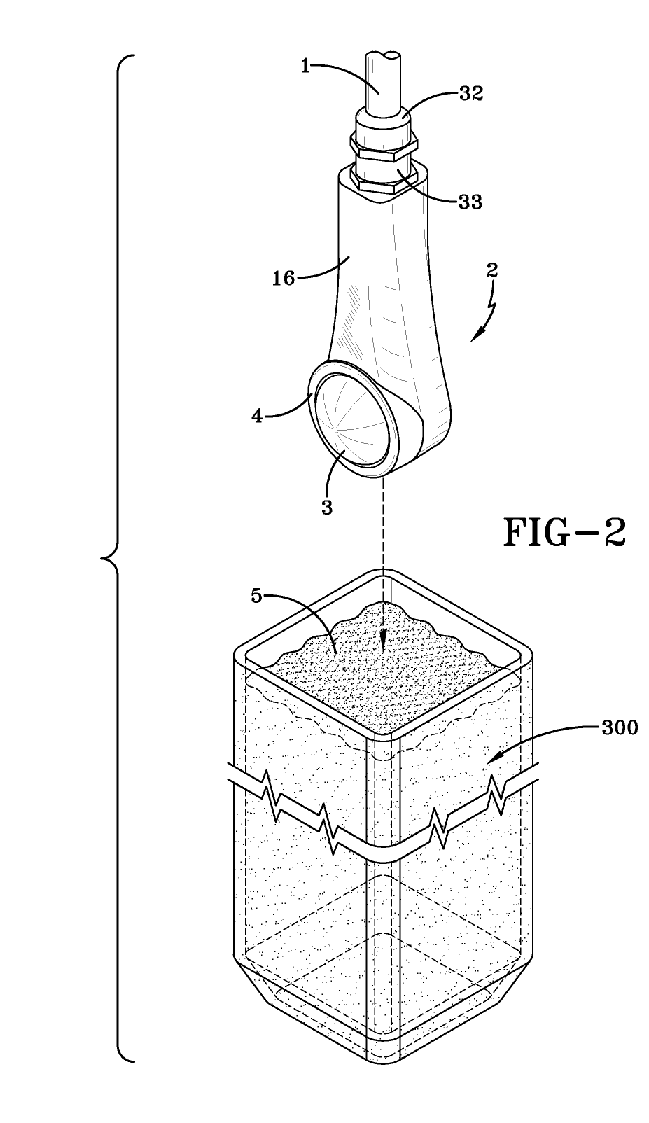

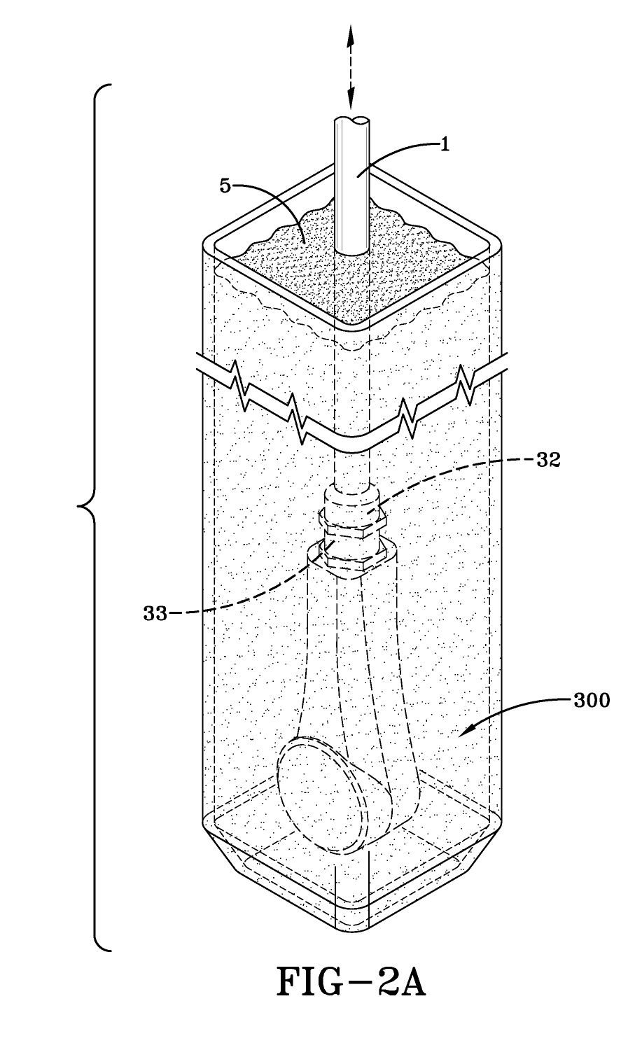

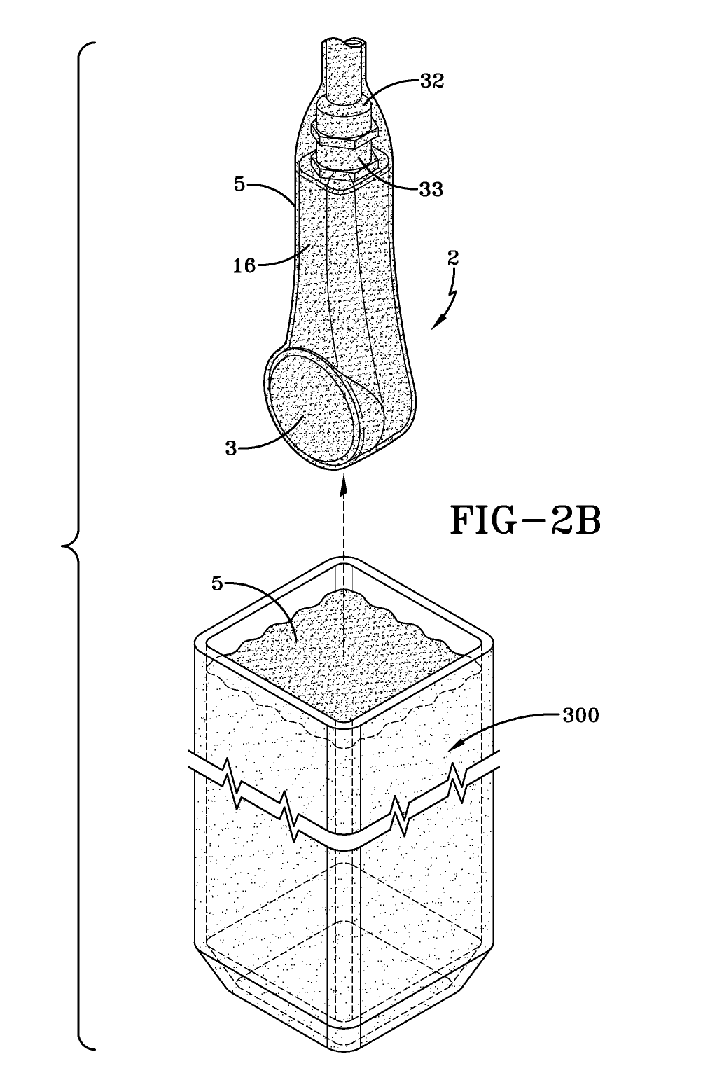

With reference to FIGS. 2, 2A and 2B it is shown that the device 2 can be provided with a hermetically sealed skin like membrane 5 by using a rather simple dipping method wherein the device connected to the cable 1 can be repeatedly dipped in the insulating elastomer such as silicone rubber held in a vat or container 300 until a desired thickness is achieved covering the entire housing and a length of the cable 1 of at least 20 cm if not extending along the entire length of the cable 1.

A noticeable alternative barrier improvement in the reflector cover 3 region where the acoustic wave transmission passes through the reflector cover 3 can be achieved by substituting the flexible lens cover 3 with a hard plastic of polyethylene or high shore hardness polyurethane which is virtually invisible to the wave propagation of the acoustic shock wave pattern.

In any event it has been found that a dip coating of at least 0.2 mm or greater, 0.2 mm being optimal for providing a sufficiently thick barrier without impeding the transmission of the shock waves. Naturally thicker coatings on the housing are permissible and away from the reflector cover 3 wave transmission path thicker coatings can be desirable.

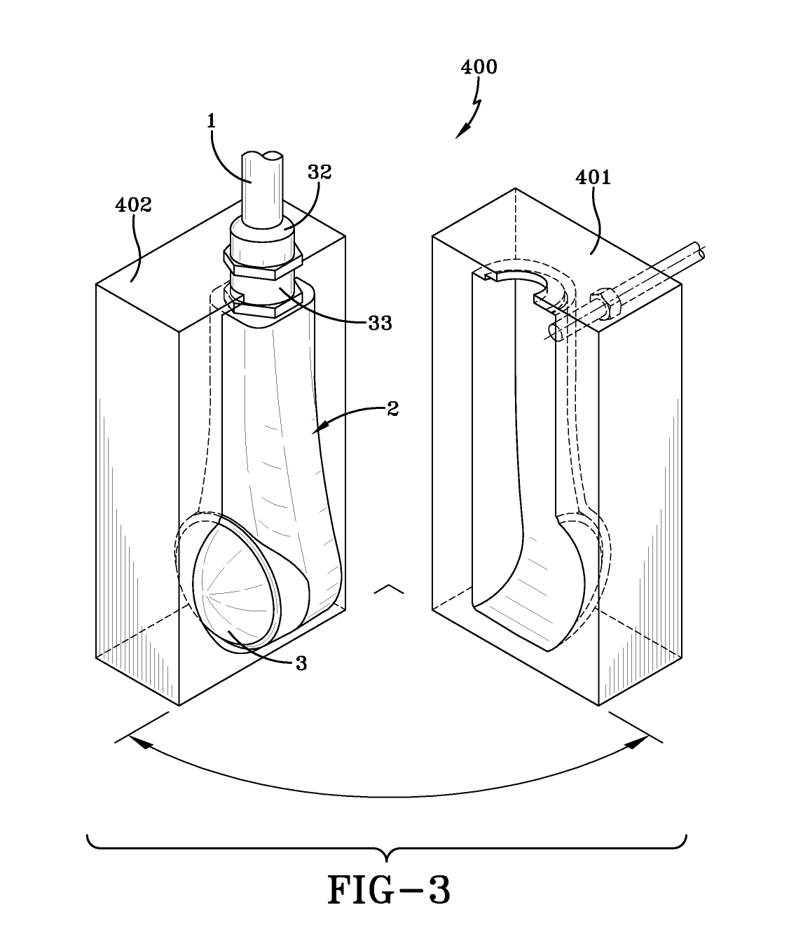

As shown in FIG. 3 an alternative method to provide another skin involves the use of insert molding the device wherein the device 2 is placed in a mold 400 having a first mold half 401 and a second mold half 402 and then plasticized silicone or urethane or other insulating material is injected around the housing hermetically sealing the device in an injected molded skin of insulating material. In such a molding method the cable connector on the housing can be sheathed in the skin 5 and the cable 1 can be separately coated with a skin membrane 5 such that upon making the connection the outer skins 5 abuttingly hermetically seal the connections. In such a molding process the skin thickness can be varied to be 0.2 mm thick or greater as in the areas not in the path of the acoustic shock wave transmission where such greater skin thicknesses are not an issue and cannot decrease the acoustic shock wave energy.

When treating an organ such as the heart the transmission of the shock waves can be triggered such that the shockwave pulse is emitted at a time when the heart is contracting. As is well known and observed in electro cardio graphs, ECG's, the heart transmits a repetitive beat or wave form often described as the QRS and T wave. The R portion of the curves includes the peak of the curve and it occurs during a heart contraction and during the contraction the heart is in a vironlevel phase such that the heart beat pattern cannot be altered during a triggering of the shockwave pulse. Accordingly it is preferred in sensitive patients that the shockwaves are transmitted during the R phase of QRS and T curves. To stimulate at other times during the heartbeat can create an alteration of the repetitive pattern of the heartbeat and could trigger an irregular and uncontrolled heart spasm which can easily be avoided by timing the shockwave pulse transmission to occur during the R curve portion of the heartbeat wave pattern. This method of controlling the transmission of the shockwave pulse can be tied to any number of repetitive body functions including, but not limited to pulse rate, pulmonary rate, breathing, brain wave activity or the like. The use of equipment monitoring devices to measure such body function can therefore be computer controlled to provide the necessary feedback to permit precise control of the triggering of the generator or shock wave source to insure a fully automated system wherein the temporal firing of the device is controlled without the need of the surgeon or physician intervention. A similar type technique of using the cardiac rhythm or pulse rate frequency of the patient was taught in U.S. Pat. No. 5,313,954 to control the shockwave frequency of generation and the subject matter of that patent is being incorporated by reference herein in its entirety. The advantage of such a technique is that it enables the determination of the frequency of extrasystoles such that the pulse generator can be deactivated for a given period of time to permit the patients circulation to regenerate itself during this interval. To do otherwise could induce irregular heart rates which in patients with weakened or damaged hearts is more problematic and potentially could be life threatening during the procedure of treatment. Accordingly in the case of treating the heart, in particular, such as the use of ECG gating to control the transmission or triggering of the shockwave pulse and the frequency of the pulse and the frequency of the pulse interval and dwell time between pulses is considered particularly important.

As shown the electrode tips 11, 13 spacing can be controlled by using the magnet 9 and the coil 10 which can move the inner tip 11 to control the gap spacing (S). Alternatively the tips 11, 13 can be replaced with adjustable electrodes using other means such as piezo ceramics, magnets, motors with gear boxes, pneumatic or hydraulic to change the tip distance.

The low cost alternative is to provide two fixed electrodes 11, 13 which are pre-set at fixed gaps and are not adjustable. In this way the entire device can be disposable adapted for a one procedure use which would provide the surgeon with a shock wave applicator device 2 capable to treat a single patient after which the device 2 can be simply discarded. This is possible due to the very low cost such a non-adjustable device 2 would require to manufacture. Alternatively any of the devices 2 can be easily refurbished by replacing worn components generally by removing the outer skin 5 and replacing the firing mechanisms such as the electrode or tips and re-dipping or molding a new outer skin 5 onto the housing to reseal the device.

In practice the use of the device 2 can be enhanced by the addition of a light and or miniature camera system (not shown) integrally attached at the head portion 40 or housing 16 of the applicator 2. The camera or light can be internal of the housing 16 and the housing can be or have a clear window portion for transmission. Preferably the light source is one or more LED's adapted for high light and low heat generation. The light and or viewing system combination can be connected to a remote optical monitor to enable the physician to focus on the rear of the organ being treated or any portion obstructed from view. Alternatively the surgeon may employ a flexible endoscope device to get light and a camera for viewing the treatment location and positioning the device 2.

The shock wave device preferably can be packaged in a sterile wrap or package and opened and connected aseptically in the operating room by the nurse or technical staff.

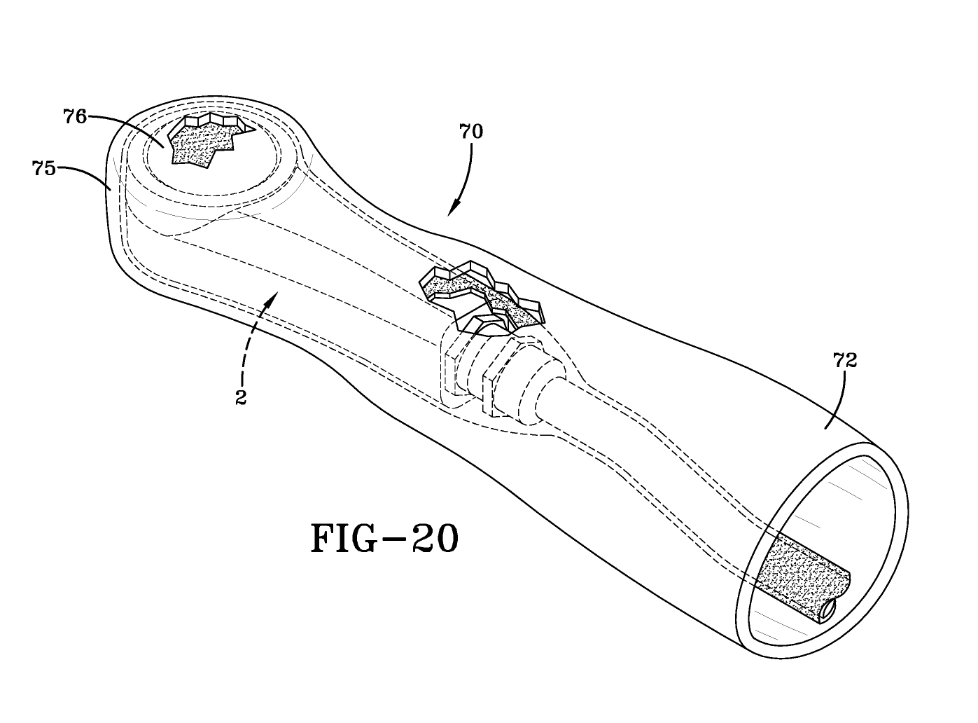

Alternatively and additionally as shown in FIG. 6 the device can be covered by a sterile prophylactic covering 70 of synthetic material similar to a latex or plastic glove. Some of these are already in use for other type of equipment which is used in the operating procedure of the open surgery. Preferably as shown in FIG. 20 the covering has a long tube like portion 72 with a closed end and an open end into which the applicator 2 and a portion of the cabling 1 can be slid into. These sterile coverings 70 or 72 being thin and flexible would not interfere with the wave transmission. Shock wave transmission between the membrane and the sleeve as well between the sleeve and the tissue has to be achieved by sterile fluid medium like NACL solution or sterile ultrasound gel or other substances with coupling properties.

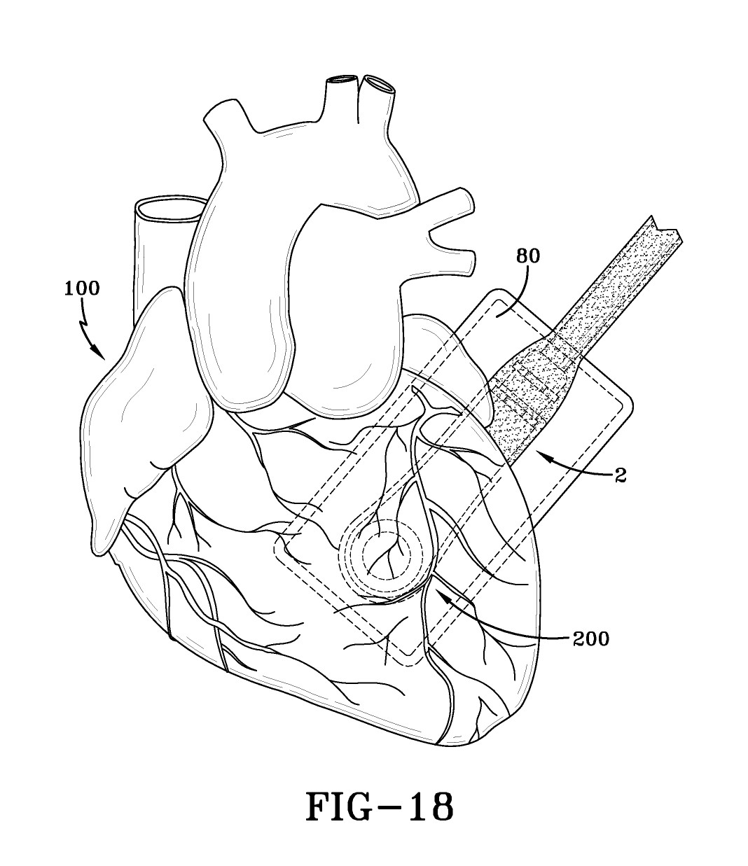

As shown in FIG. 20 the sleeve 70 may include an integral shield 75 formed by an air filled double layer membrane or other wave dampening material such that the area above the reflector 15 or transmission zone directly under the outer reflector cover 3 is a single layer 76 not shielded, but other areas such as the back and sides of the device are shielded. Alternatively as shown in FIG. 18 a simple shield 80 may be used that is a wave damping sterile pad or layer positioned between a sterile device 2 and the underlying lungs (not shown) above the heart.

The device 2 can be alternatively configured to provide a leakage detection system which will include a vacuum line 82 that passes through the cable 1 and is connected to a tubular connector 87 attached to an internal conduit 88 in the housing 16. The conduit 88 passes along the side of the housing 16 to an opening 89 adjacent to the reflector 3 but internal of the housing 16 such that any leakage from the cavity 30 of the fluid under pressure or any leakage of the patient's bodily fluids could be detected by a drop in vacuum pressure.

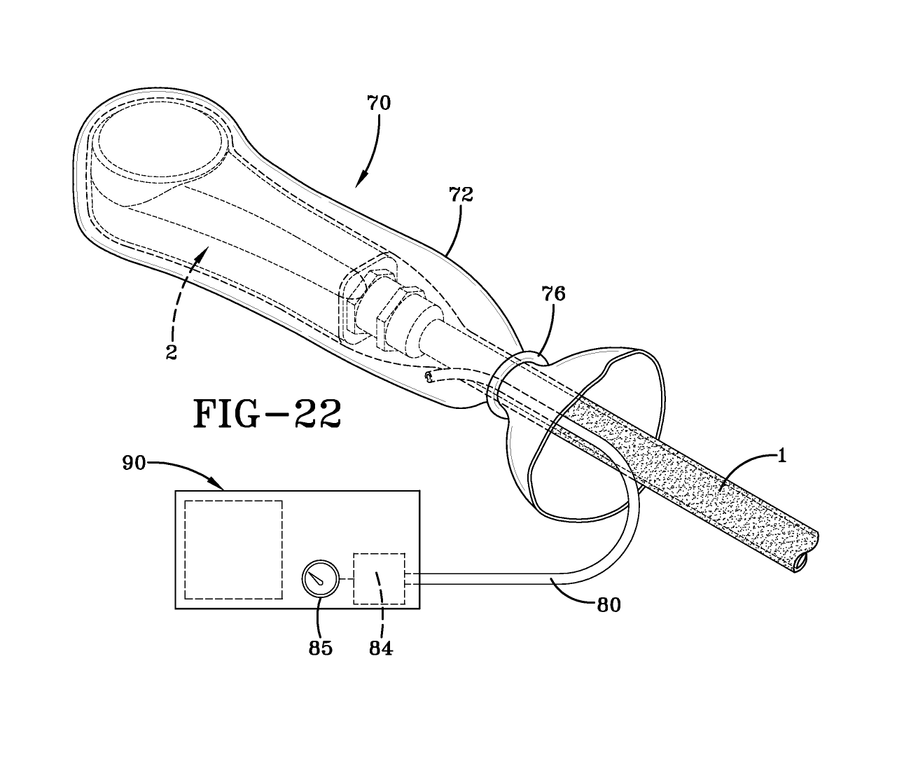

With reference to FIG. 22 the device 2 alternatively can be placed in a sleeve 70 that further includes an o ring 76 that seals the sleeve 70 against the cable 1 in such a fashion that a vacuum line 80 internal of the sleeve 70 can be placed between the sleeve 70 and the device 2 and the vacuum can be monitored at a control station 90 wherein a meter 85 can be visually observed and a detection of the vacuum dropping below a prescribed level would be an indication of a leak or a hole in the outer prophylactic sleeve 70 such that the vacuum system will detect any fluids that are entering through any cuts or openings in the prophylactic sleeve 70. These features are important in that the high voltages used in the device must not short out and electrically pass into the patient. The fluids internal of the device 2 should not leak outward to enter into the patient's bloodstream during the procedure and by providing these vacuum detection systems it is possible to immediately see any indication of a pressure drop or change in vacuum between the sleeve 70 and the device 2 such that if the device 2 is leaking the doctor can immediately pull the device 2 out of the patient's wound site to insure that there aren't fluids entering into the patient's body. Alternatively any opening of the sleeve 70 that would draw the patient's body fluids in can also be detected and that would cause the doctor to withdraw the device 2 and to check the sleeve 70 for any cuts or tears, replacing the sleeve 70 if necessary.

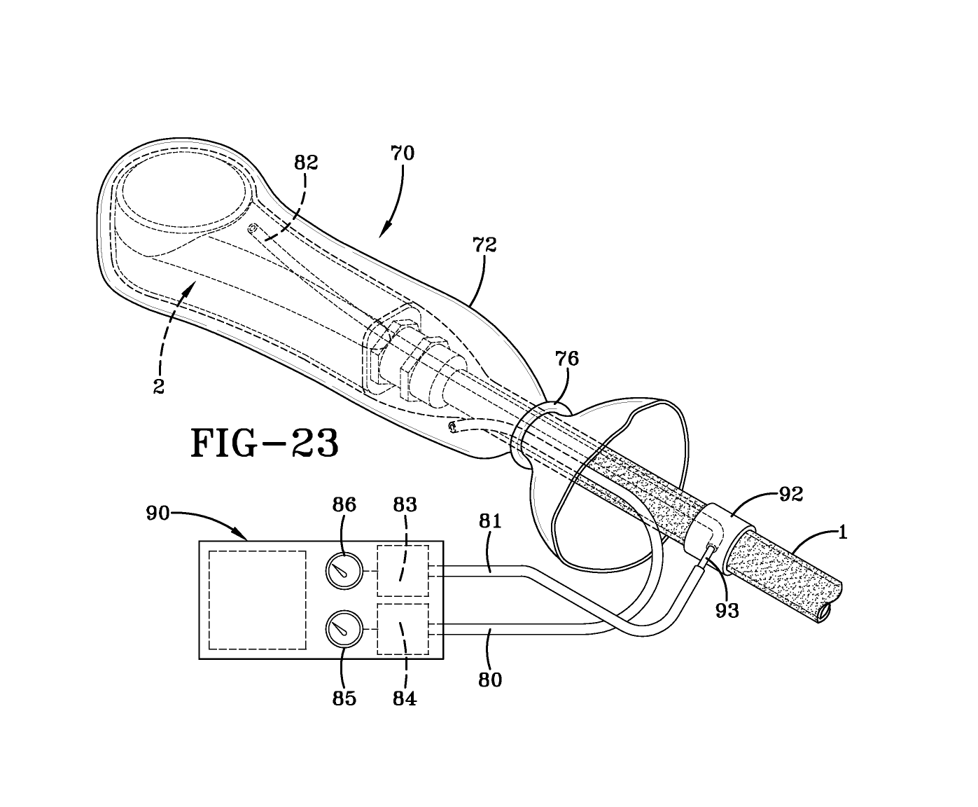

With reference to FIG. 23 the device 2 is shown with an internal vacuum system internal of the housing 16 and also employs the vacuum system between the sleeve 70 and the device 2 such that the vacuum tubing lines 80 and 81 are connected to a detection means 90 with a visual indication of the vacuum in each line 80 and 81, each line can be separately operated by a pump 84 or 85 at the control detection means station 90 as shown schematically. In each of the vacuum lines 80 or 81 shown are connected to pump 83, 84 with a vacuum pressure indicator 85 or 86. It is also possible that these could be electronically controlled at the control panel 90 such that the vacuum would give an electronic signal that can either be audible or a light flashing when a detection of a leak occurs. While the two lines 80, 81 are shown connected to separate pumps 83, 84 it is possible a single pump can service both lines and the vacuum can still be measured separately by a suitable switching means (not shown). In any event the use of these vacuum systems enables a leakage detection capability to be provided as an additional precautionary safety feature.

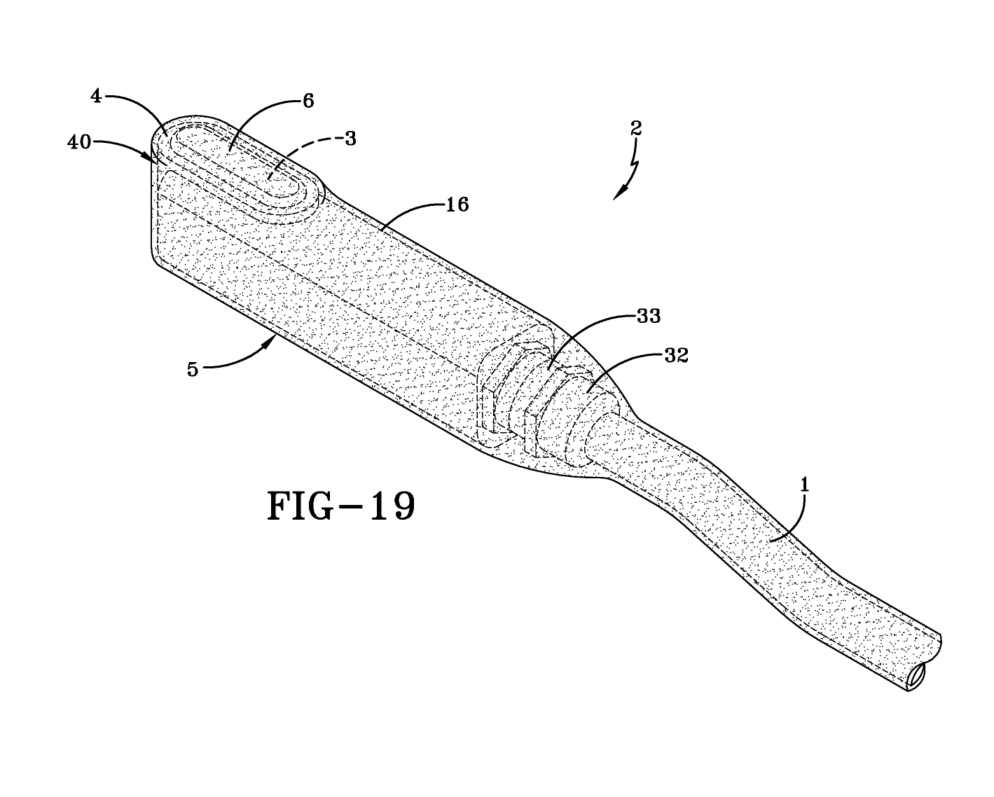

With reference to FIGS. 4 and 5 the reflector 15 it has the internal cavity 30 shown as a generalized paraboloid with a very divergent wave to stimulate the infarct tissue of a heart directly at the applicator exit or reflector cover 3 while only having a low pressure amplitude when being transmitted through the heart tissue which potentially might enter into the lung tissue. Alternatively, as shown in FIG. 19 the applicator device 2 can be made with an elliptical head portion 40, the reflector cavity 30 might be an ellipsoid with its focal point about 1-2 cm after the aperture. This will make possible that the heart wall will be behind the focal point (F2 geometrical) and the divergent beam of the shock wave is treating the tissue. The lung on the other side of the heart will be in the already low pressure because of the divergent shock wave amplitude (pressure). This is the case when the distance to the focal point is very big. In an unfocused spherical wave the pressure of the energy density is lowered according to l/distance2 and such a wave form can be emitted using the applicator device 2. It is possible to use a small focal depth of f2 equal to 1-2 cm so that the focal point is in the heart wall. Accordingly the treatment can involve putting the heart tissue depending on the focal distance f2 in the converging focusing beam or in the focus or in the divergent part behind the focus.

These and other aspects of the reflector characteristics and the use of the shock wave head have been described in co-pending application U.S. Ser. No. 11/238,731 portions of which are restated for a clear understanding of the method and use of the inventive device described above.

In the shock wave method of treating an organ of a mammal be it human or an animal with an at least partially exposed target site on the organ, the organ is positioned in a convenient orientation to permit the source of the emitted waves to most directly send the waves unobstructed to the target site to initiate shock wave stimulation of the target area with minimal, preferably no interfering tissue or bone features in the path of the emitting source or lens or reflector cover 3 or outer skin 5. Assuming the target area is within a projected area of the wave transmission, a single transmission dosage of wave energy may be used. The transmission dosage can be from a few seconds to 20 minutes or more dependent on the condition. The number of shock waves could be from 10 to a few hundred or a few thousand within one treatment. The repletion frequency of shock waves per second could be from 0.5-20 per second. Preferably the waves are generated from an unfocused or focused source. Preferably the shock waves should be emitted at maximum energy densities of about 0.3 mJ/mm² or less. The unfocused waves can be divergent or near planar and having a low pressure amplitude and density in the range of 0.00001 mJ/mm² to 0.3 mJ/mm² or less, most typically below 0.2 mJ/mm². The focused source preferably can use a diffusing lens or have a far-sight focus to minimize if not eliminate having the localized focus point within the tissue. Preferably the focused shock waves are used at a similarly effective low energy transmission or alternatively can be at higher energy but wherein the tissue target site is disposed pre-convergence inward of the geometric focal point of the emitted wave transmission.

These shock wave energy transmissions are effective in stimulating a cellular response and can be accomplished without creating the cavitation bubbles in the tissue of the target site. This effectively insures the organ does not have to experience the sensation of hemorrhaging so common in the higher energy focused wave forms having a focal point at or within the targeted treatment site. It is intended not to generate any cavitation bubbles, but it is recognized difficult to avoid them 100%. Accordingly the treatments discussed clearly can minimize such occurrences.

If the target site is an organ subjected to a surgical procedure exposing at least some if not all of the organ within the body cavity the target site may be such that the patient or the portable shock wave applicator device 2 must be reoriented relative to the site and a second, third or more treatment dosage can be administered. The fact that the dosage is at a low energy the common problem of localized hemorrhaging is reduced making it more practical to administer multiple dosages of waves from various orientations to further optimize the treatment and cellular stimulation of the target site. Heretofore focused high energy multiple treatments induced pain and discomfort to the patient. The use of low energy focused or un-focused waves at the target site enables multiple sequential treatments.

The present method does not rely on precise site location per se. The physician's general understanding of the anatomy of the patient should be sufficient to locate the target area to be treated. This is particularly true when the exposed organ is visually within the surgeon's line of sight and this permits the lens or reflector cover 3 of the emitting shock wave applicator 2 to impinge on the organ tissue directly during the shockwave treatment. The treated area can withstand a far greater number of shock waves based on the selected energy level being emitted. For example at very low energy levels the stimulation exposure can be provided over prolonged periods as much as 20 minutes if so desired. The number of shock waves could be from 10 to a few hundred or a few thousand within one treatment. The repletion frequency of shock waves per second could be from 0.5-20 per second. At higher energy levels the treatment duration can be shortened to less than a minute, less than a second if so desired. The limiting factor in the selected treatment dosage is avoidance or minimization of cell hemorrhaging and other kinds of damage to the cells or tissue while still providing a stimulating stem cell activation or a cellular release or activation of VEGF and other growth factors.

The underlying principle of these shock wave therapy methods is to stimulate the body's own natural healing capability. This is accomplished by deploying shock waves to stimulate strong cells in the tissue to activate a variety of responses. The acoustic shock waves transmit or trigger what appears to be a cellular communication throughout the entire anatomical structure, this activates a generalized cellular response at the treatment site, in particular, but more interestingly a systemic response in areas more removed from the wave form pattern. This is believed to be one of the reasons molecular stimulation can be conducted at threshold energies heretofore believed to be well below those commonly accepted as required. Accordingly not only can the energy intensity be reduced but also the number of applied shock wave impulses can be lowered from several thousand to as few as one or more pulses and still yield a beneficial stimulating response.

The use of shock waves as described above appears to involve factors such as thermal heating, light emission, electromagnetic field exposure, chemical releases in the cells as well as a microbiological response within the cells or intracellular. Which combination of these factors plays a role in stimulating healing is not yet resolved. However, there appears to be a commonality in the fact that growth factors are released which applicants find indicative that otherwise dormant cells within the tissue appear to be activated which leads to the remarkable ability of the targeted organ or tissue to generate new growth or to regenerate weakened vascular networks in for example the cardio vascular system.

The use of shock wave therapy requires a fundamental understanding of focused and unfocused shock waves, coupled with a more accurate biological or molecular Focused shock waves are focused using ellipsoidal reflectors in electromechanical sources from a cylindrical surface or by the use of concave or convex lenses. Piezoelectric sources often use spherical surfaces to emit acoustic pressure waves which are self focused and have also been used in spherical electromagnetic devices.

The biological model proposed by co-inventor Wolfgang Schaden provides a whole array of clinically significant uses of shock wave therapy.

Accepting the biological model as promoted by W. Schaden, the peak pressure and the energy density of the shock waves can be lowered dramatically. Activation of the body's healing mechanisms will be seen by in growth of new blood vessels and the release of growth factors.

The biological model motivated the design of sources with low pressure amplitudes and energy densities. First: spherical waves generated between two tips 11, 13 of an electrode; and second: nearly even waves generated by generalized parabolic reflectors. Third: divergent shock front characteristics are generated by an ellipsoid behind F2. Unfocused sources are preferably designed for extended two dimensional areas/volumes like skin. The unfocused sources can provide a divergent wave pattern or a nearly planar wave pattern and can be used in isolation or in combination with focused wave patterns yielding to an improved therapeutic treatment capability that is non-invasive with few if any disadvantageous contraindications. Alternatively a focused wave emitting treatment may be used wherein the focal point extends preferably beyond the target treatment site, potentially external to the patient. This results in the reduction of or elimination of a localized intensity zone with associated noticeable pain effect while providing a wide or enlarged treatment volume at a variety of depths more closely associated with high energy focused wave treatment. The utilization of a diffuser type lens or a shifted far-sighted focal point for the ellipsoidal reflector enables the spreading of the wave energy to effectively create a convergent but off target focal point. This insures less tissue trauma while insuring cellular stimulation to enhance the healing process. The device as shown has an ellipsoidal reflector that provides a generally focused beam. The device alternatively can be used or fitted to provide a variety of shock wave fronts. Some of which are discussed as follows.

This method of treatment has the steps of, locating a treatment site, generating either convergent diffused or far-sighted focused shock waves or unfocused shock waves, of directing these shock waves to the treatment site; and applying a sufficient number of these shock waves to induce activation of one or more growth factors thereby inducing or accelerating healing.

The unfocused shock waves can be of a divergent wave pattern or near planar pattern preferably of a low peak pressure amplitude and density. Typically the energy density values range as low as 0.000001 mJ/mm² and having a high end energy density of below 1.0 mJ/mm², preferably 0.20 mJ/mm² or less. The peak pressure amplitude of the positive part of the cycle should be above 1.0 and its duration is below 1-3 microseconds.

The treatment depth can vary from the surface to the full depth of the treated organ. The treatment site can be defined by a much larger treatment area than the 0.10-3.0 cm² commonly produced by focused waves. The above methodology is particularly well suited for surface as well as sub-surface soft tissue organ treatments.

The above methodology is valuable in generation of tissue, vascularization and may be used in combination with stem cell therapies as well as regeneration of tissue and vascularization.

The methodology is useful in (re)vascularization of the heart, brain, liver, kidney and skin.

The methodology is useful in stimulating enforcement of defense mechanisms in tissue cells to fight infections from bacteria and can be used germicidally to treat or cleanse wounds or other target sites.

Conditions caused by cirrhosis of the liver can be treated by reversing this degenerative condition.

The implications of using the (re)generative features of this type of shock wave therapy are any weakened organ or tissue even bone can be strengthened to the point of reducing or eliminating the risk of irreparable damage or failure.

The stimulation of growth factors and activation of healing acceleration is particularly valuable to elderly patients and other high risk factor subjects.

Similar gains are visualized in organ transplant and complete organ regeneration, wherein a heart, liver, kidney, portions of the brain or any other organ or portions thereof of a human or animal may be transplanted into a patient, the organ being exposed to shock waves either prior to or after being transplanted.

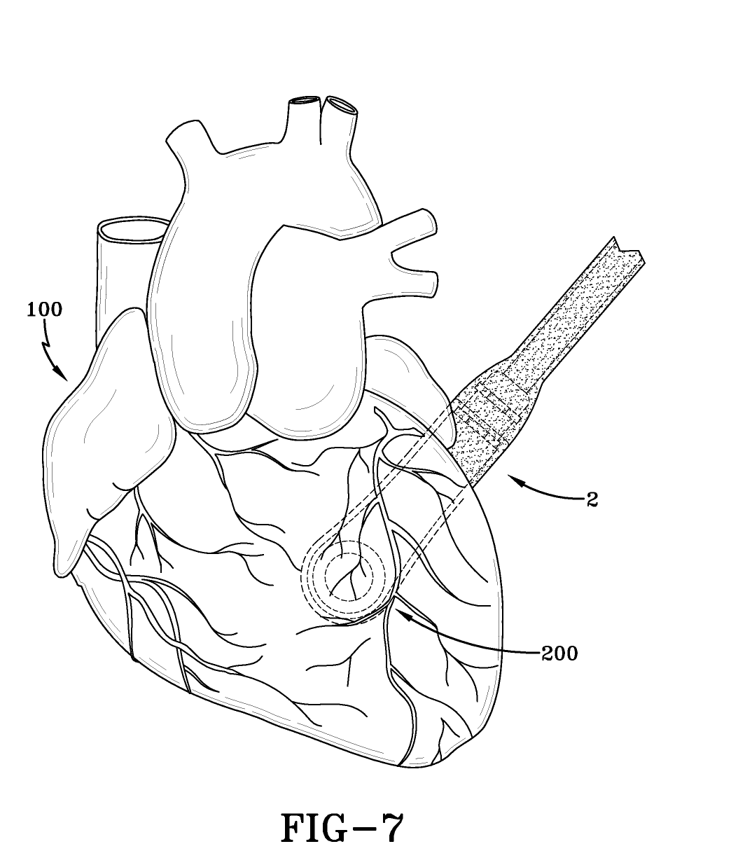

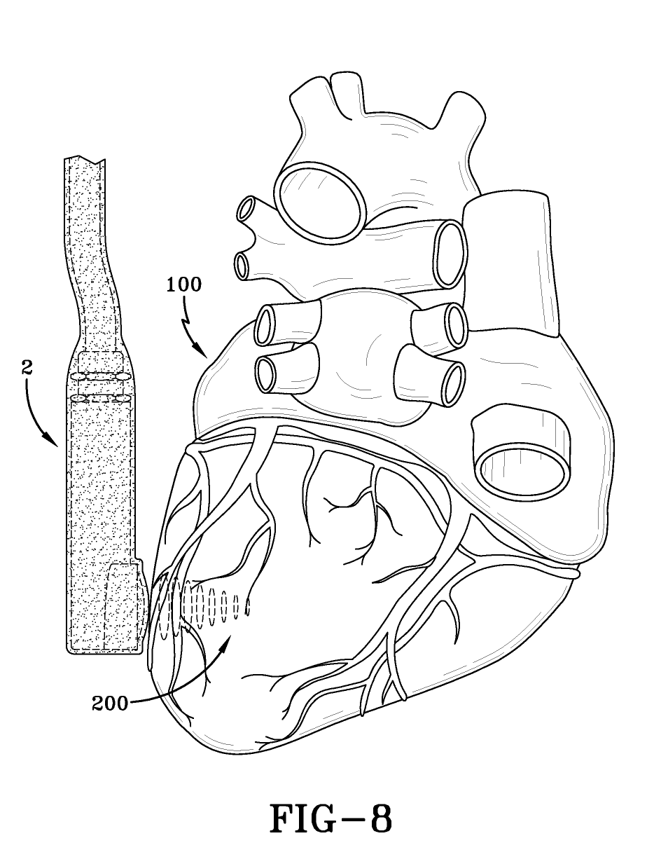

With reference to FIGS. 7 and 8 the organ 100 shown is a heart. In FIG. 7 a frontal view of the heart is shown wherein the frontal region is being bombarded with exemplary shock waves 200 wherein the shockwave applicator 2 is shown unobstructed to the tissue of the heart. The shockwave applicator 2 is connected through the cable 1 back to a control and power supply 41, as shown in FIG. 12. As illustrated the exemplary shock waves 200 emanate through the tissue of the heart providing a beneficial regenerating and revascularization capability that heretofore was unachieved. The beneficial aspects of the present methodology are that the heart 100 as shown fully exposed in the views FIGS. 7 and 8 can be partially exposed or have an access portal such that the shock wave head 2 can be inserted therein and directed to contact or be in near contact to the heart tissue is such a way that the admitted exemplary shock waves 200 can most directly and in the most unobstructed way be transmitted to the region needing treatment. The heart itself can be lifted in the myocardial cavity and the applicator 2 positioned beneath the heart and firing the wave pattern upwardly into the tissue as shown in FIG. 8. While the use of the shock wave applicator 2 in this fashion is clearly invasive it also has the beneficial aspects of providing a direct treatment to the cardiovascular area in need of regenerative or revascularization enhancement.

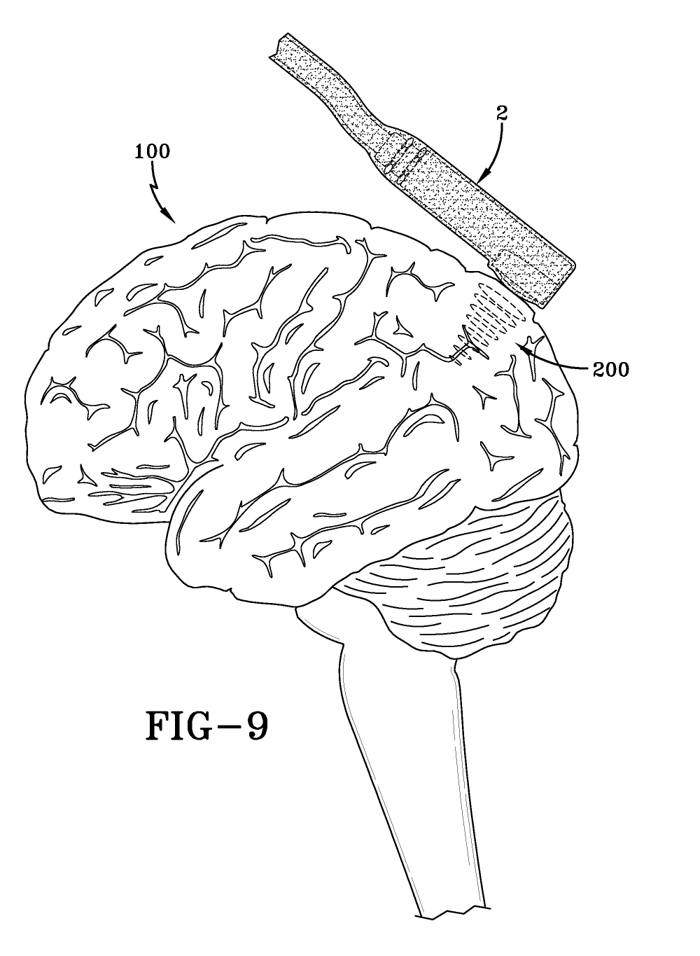

With reference to FIG. 9, the organ 100 is a brain. As shown the brain and brain stem are completely exposed, however, normally only a small portion of the cranial cavity would be open such that the shockwave applicator 2 can be inserted therein to provide therapeutic shock wave treatments preferably of very low amplitude for stimulating certain regions of the brain for regenerative purposes.

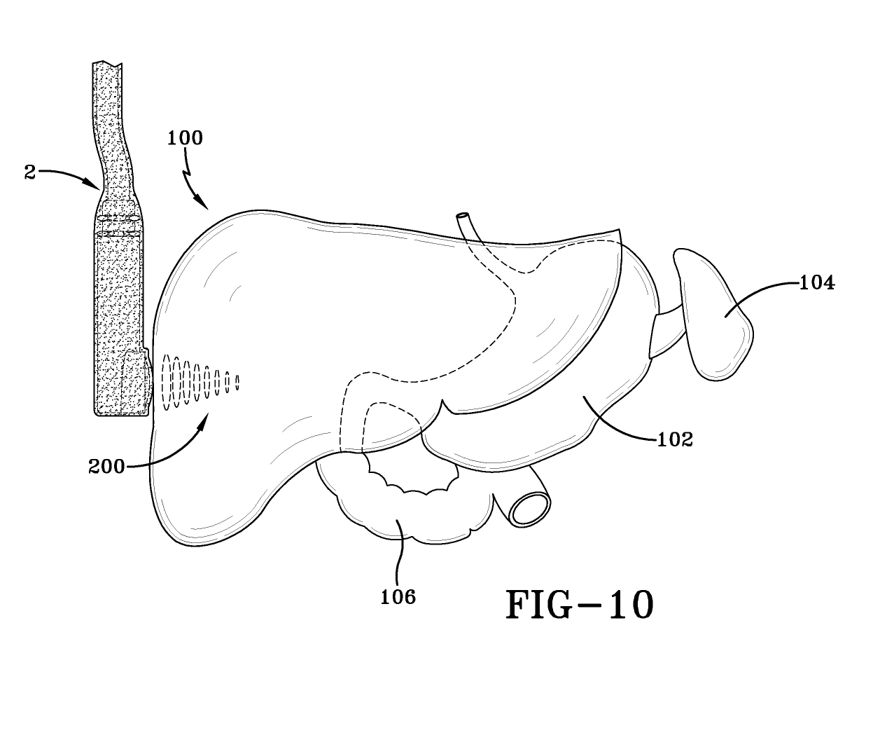

In FIG. 10 a liver 100 is shown. In addition to the liver 100, the stomach 102, spleen 104 and duodenum 106 are also shown. The shock wave applicator 2 is in contact with the liver 100 and is providing a therapeutic shock wave treatment as illustrated wherein the exemplary shock waves 200 are being transmitted through the tissue of the liver. It is believed that the use of such exemplary shock waves 200 can help in enhancing liver regeneration particularly those that have been degenerative and in conditions that might be prone to failure. Again the liver 100 is shown fully exposed, however, in normal procedure only an access portal or opening may be needed such that the shock wave applicator 2 can be inserted there through and provide a direct unobstructed path to deliver shockwave treatments to this organ as well.

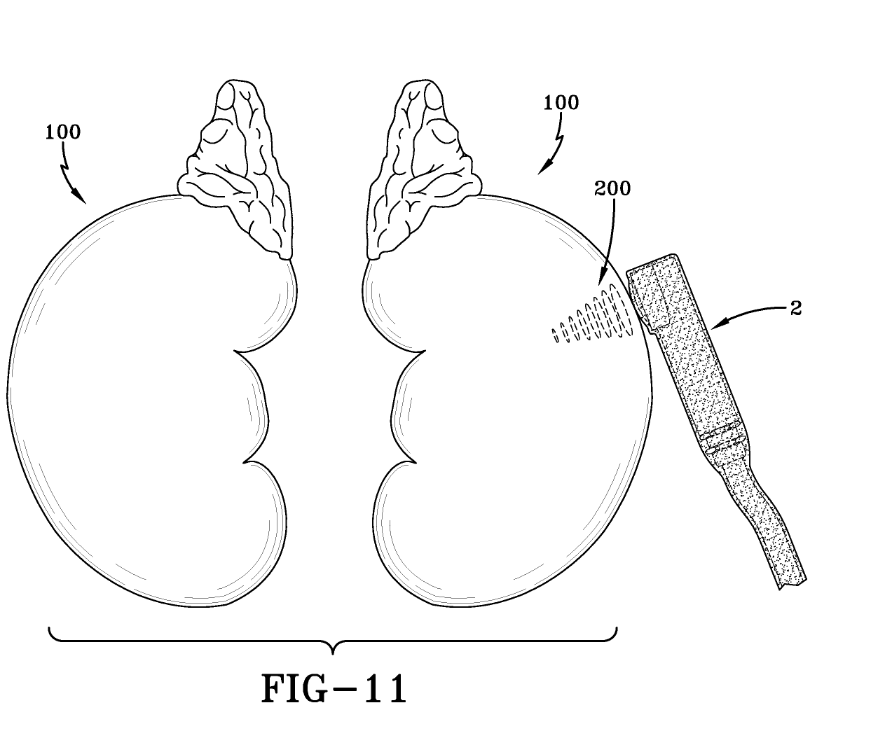

In FIG. 11 a pair of kidneys 100 is shown as the organ 100 being treated. In this fashion the kidneys similar to the liver, brain or heart can be treated such that the shock wave applicator 2 can be in direct or near contact in an unobstructed path to admit shock waves 200 to this organ. This has the added benefit of generating maximum therapy to the afflicted organ in such a way that the healing process can be stimulated more directly. Again in each of these procedures as shown there is an invasive technique requiring the shock wave applicator 2 to enter either an access portal or an opening wherein the organ 100 is at least partially exposed to the exemplary shock waves 200 as can either be accomplished by a surgical procedure or any other means that would permit entry of the shock wave applicator 2 to the afflicted organ.

In each of the representative treatments as shown in FIGS. 7 through 11 the shockwave applicator 2 when used within a sterile sleeve or covering 70 as shown in FIGS. 6 or 20 may simply be disinfected using a suitable antimicrobial disinfecting agent prior to use. Alternatively the applicator 2 may be sterilized when used without a sterile sleeve. As shown the sleeves or coverings 70 are preferably disposable and should be discarded after use. When treating any tissue or organ 100 the sterile sleeve 70 holding the applicator 2 or in the case of using the applicator 2 without a sleeve the tissue contacting surface should be coupled acoustically by using known means such as sterile fluids or viscous gels like ultrasound gels or even NaCl solutions to couple the transmitted shock wave into the organ in an aseptic sterile fashion.

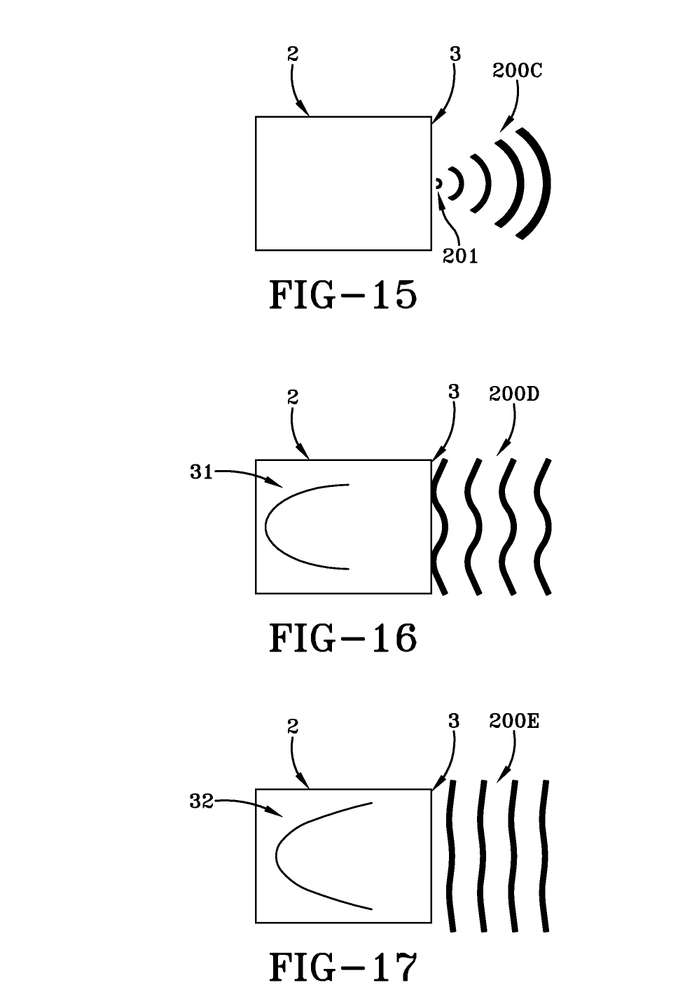

In FIGS. 7-11 exemplary shock waves 200 are illustrated, it must be appreciated that any of the recognized shock wave patterns exhibited in FIGS. 13-17 can be used in the shock wave treatment of the various organs 100.

Heretofore such invasive techniques were not used in combination with shock wave therapy primarily because the shockwaves were believed to be able to sufficiently pass through interfering body tissue to achieve the desired result in a non-invasive fashion. While this may be true, in many cases if the degenerative process is such that an operation is required then the combination of an operation in conjunction with shockwave therapy only enhances the therapeutic values and the healing process of the patient and the organ such that regenerative conditions can be achieved that would include not only revascularization of the heart or other organs wherein sufficient or insufficient blood flow is occurring but also to enhance the improvement of ischemic tissue that may be occupying a portion of the organ. This ischemic tissue can then be minimized by the regenerative process of using shock wave therapy in the fashion described above to permit the tissue to rebuild itself in the region that has been afflicted.

As used throughout this application wherein the use of exemplary shock waves 200 in an unobstructed path has been described unobstructed path means that there is no or substantially no interfering tissue or bone skeletal mass between the shock wave applicator 2 and the treated organ. It is believed that the elimination of such interfering masses greatly enhances the control and the efficiency of the emitted exemplary shock waves 200 to create the desired beneficial healing effects and regenerative process needed for the organ to be repaired.

Furthermore such acoustic shock wave forms can be used in combination with drugs, chemical treatments, irradiation therapy or even physical therapy and when so combined the stimulated cells will more rapidly assist the body's natural healing response.

The present invention provides an apparatus for an effective treatment of indications, which can benefit from low energy pressure pulse/shock waves having nearly plane or even divergent characteristics. With an unfocused wave having nearly plane wave characteristic or even divergent wave characteristics, the energy density of the wave may be or may be adjusted to be so low that side effects including pain are very minor or even do not exist at all. The use of the focus shock wave beams while generally employed at a higher energy pressure density are also beneficially useable in this type of open or accessible organ treatment and can be accomplished with minimal occurrence of hemorrhaging if properly conducted.

In certain embodiments, the apparatus of the present invention is able to produce waves having energy density values that are below 0.3 mJ/mm2 or even as low as 0.000 001 mJ/mm2. In a preferred embodiment, those low end values range between 0.1-0.001 mJ/mm2. With these low energy densities, side effects are reduced and the dose application is much more uniform. Additionally, the possibility of harming surface tissue is reduced when using an apparatus of the present invention that generates waves having nearly plane or divergent characteristics and larger transmission areas compared to apparatuses using a focused shock wave source that need to be moved around to cover the affected area. The apparatus of the present invention also may allow the user to make more precise energy density adjustments than an apparatus generating only focused shock waves, which is generally limited in terms of lowering the energy output.

The treatment of the above mentioned indications are believed to be a first time use of acoustic shock wave therapy invasively. None of the work done to date has treated the above mentioned indications with convergent, divergent, planar or near-planar acoustic shock waves of low energy or focused shock waves in a direct unobstructed path from the emitting source lens or cover using the soft fluid filled organ as a transmitting medium directly. As is the use of acoustic shock waves for germicidal wound cleaning or preventive medical treatments.

With reference to FIGS. 13-17 the applicator 2 of the present invention can be provided with a reflector cavity 30 shaped or contoured to reflect the generated wave pattern 200 in a variety of shapes or geometric forms. In each of the following figures the wave pattern 200 includes a geometric pattern specific subset 200A through 200E.

FIG. 13 is a simplified depiction of the pressure pulse/shock wave (PP/SW) generator, such as the shock wave applicator 2 showing focusing characteristics of transmitted acoustic pressure pattern 200A. The pattern as illustrated has waves that are converging as shown.

This converging wave pattern 200A is commonly used in focused shock wave treatments wherein the focal point F₂ is targeted at a specific point in the tissue mass 100. Alternatively the wave pattern can be used off target to avoid the high energy focal region if so desired. These wave patterns 200A are most commonly produced by using an ellipsoidal shaped reflector surface in the cavity 30.

FIG. 14 is a simplified depiction of a pressure pulse/shock wave generator, such as a shock wave head, with plane wave characteristics. Numeral 2 indicates the position of a pressure pulse applicator 2 according to the present invention, which generates a pressure pulse wave pattern 200B which is leaving the housing at the reflector cover 3, which may be a water cushion or any other kind of exit window. Somewhat even (also referred to herein as “disturbed”) wave characteristics can be generated, in case a paraboloid is used as a reflecting element, with a point source (e.g. electrode) that is located in the focal point of the paraboloid. The waves will be transmitted into the patient's body via a coupling media such as, e.g., ultrasound gel or oil and their amplitudes will be attenuated with increasing distance from the exit window or membrane 3.

FIG. 15 is a simplified depiction of a pressure pulse shock wave generator (shock wave head) with divergent wave characteristics. The divergent wave fronts 200C may be leaving the reflector cover 3 at point 201 where the amplitude of the wave front is very high. This point 201 could be regarded as the source point for the pressure pulses 200C. The pressure pulse source may be a point source, that is, the pressure pulse may be generated by an electrical discharge of an electrode under water between electrode tips. However, the pressure pulse may also be generated, for example, by an explosion.

FIG. 16 is a simplified depiction of the pressure pulse/shock wave generator (shock wave head) having as a focusing element an paraboloid (y²=2px). Thus, the characteristics of the wave fronts 200D generated behind the exit window 3 are disturbed plane (“parallel”), the disturbance resulting from phenomena ranging from electrode burn down, spark ignition spatial variation to diffraction effects. However, other phenomena might contribute to the disturbance. This is common in so called planar patterns.

FIG. 17 is a simplified depiction of the pressure pulse/shock wave generator (shock wave head) having as a focusing element a generalized paraboloid (yⁿ=2px, with 1,2<n<2,8 and n≠2). Thus, the characteristics of the wave fronts 200E generated behind the exit window or reflector cover or lens 3 are, compared to the wave fronts generated by a paraboloid (y²=2px), less disturbed, that is, nearly plane (or nearly parallel or nearly even). Thus, conformational adjustments of a regular paraboloid (²=2px) to produce a generalized paraboloid can compensate for disturbances from, e.g., electrode burn down. Thus, in a generalized paraboloid, the characteristics of the wave front may be nearly plane due to its ability to compensate for phenomena including, but not limited to, burn down of the tips of the electrode and/or for disturbances caused by diffraction at the aperture of the paraboloid. For example, in a regular paraboloid (y²=2px) with p=1.25, introduction of a new electrode may result in p being about 1.05. If an electrode is used that adjusts itself to maintain the distance between the electrode tips (“adjustable electrode”) and assuming that the electrodes burn down is 4 mm (z=4 mm), p will increase to about 1.45. To compensate for this burn down, and here the change of p, and to generate nearly plane wave fronts over the life span of an electrode, a generalized paraboloid having, for example n=1.66 or n=2.5 may be used. An adjustable electrode is, for example, disclosed in U.S. Pat. No. 6,217,531.

Various wave patterns 200A-200E are by no means intended to be more than exemplary and any such wave pattern or type may be used at the surgeon's discretion. Accordingly the depiction 200 in FIGS. 7-12 are intended to mean any style of wave pattern emitted including, but not limited to the subset 200A-200E. Furthermore, while the large discussion of low energy shock wave pattern use provided, it is also understood the use of a focused beam of wave patterns in many cases may be preferred to be used even at the higher energies on the exposed tissue of an organ being treated.

It will be appreciated that the apparatuses and processes of the present invention can have a variety of embodiments, only a few of which are disclosed herein. It will be apparent to the artisan that other embodiments exist and do not depart from the spirit of the invention. Thus, the described embodiments are illustrative and should not be construed as restrictive.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A shock wave applicator device comprising
an outer housing structure for internally containing a plurality of components for generating an acoustic shock wave; and
an outer skin sealing the outer housing along the exterior surfaces of the housing.

2. The shock wave applicator device of claim 1 wherein the outer skin is 0.2 mm thick or greater.

3. The shock wave applicator device of claim 1 wherein the outer skin is made of a polymer material.

4. The shock wave applicator device of claim 3 wherein the outer skin is made of a silicone material.

5. The shock wave applicator device of claim 3 wherein the outer skin is made of a polyurethane material.

6. The shock wave applicator device of claim 1 further comprises:
a reflector internal of the housing for redirecting and shaping a shock wave pattern transverse to the shock wave device; and
a reflector cover overlying the reflector for transmitting the wave pattern.

7. The shock wave applicator device of claim 1 further comprises:
a connector attached to the housing;
a cable connected to the connector; and
wherein the skin membrane extends along the connections and at least a length of 20 cm of the cable.

8. The shock wave applicator device of claim 1 further comprises an internal vacuum conduit internal of said housing and connected to vacuum system for maintaining a leakage detection capability.

9. The shock wave applicator device of claim 1 further includes a sterile sleeve covering and the applicator is treated with a disinfecting agent prior to being placed in the sterile sleeve or covering.

10. The shock wave applicator of claim 9 wherein the sterile sleeve covering further comprises a vacuum line for detecting any leakage internal of the sterile sleeve.

11. The shock wave applicator device of claim 1 wherein the device is sterilized prior to use in open surgery.

12. The shock wave applicator device of claim 1 wherein the shock wave head generates shock wave by either electro hydraulic, electro magnetic, piezoelectric or ballistic wave emissions.

13. The shock wave applicator device of claim 1 wherein the device is disposable after a single use.

14. The shock wave applicator device of claim 1 wherein the device includes replaceable electrodes or tips for refurbishing the device after use.

15. The shock wave applicator device of claim 1 further comprises:
two fixed electrodes which are not adjustable and are pre-set at fixed gaps.

16. The shock wave applicator device of claim 1 further comprises:
one or more adjustable electrodes.

17. The shock wave applicator device of claim 1 wherein the adjustable electrodes include one or more adjustment means, the means being magnets, piezo ceramic or motors with gear boxes, pneumatic or hydraulic to change the tip distance.

18. A method of sealing a shock wave applicator device with an external housing comprises the steps of:
dipping the device in a polymer to form a thin outer skin.

19. The method of sealing the shock wave device of claim 16 further comprising:
repeating the step of dipping until a skin thickness of 0.2 mm or greater is achieved.

20. The method of sealing a shock wave applicator device housing comprised the steps of:
placing the device in a mold;
closing the mold; and
injecting a polymer surrounding said housing thereby forming an outer skin of 0.2 mm or greater.
